(19) United States
(12) Patent Application Publication
(10) Pub. No.: US 2011/0145077 A1
(43) Pub. Date: Jun. 16, 2011

(54) SETTLEMENT TERMINAL, CONTROL METHOD THEREFOR, AND POS TERMINAL

(75) Inventor: Masatoshi Nochi, Shizuoka (JP)

(73) Assignee: TOSHIBA TEC KABUSHIKI KAISHA, Tokyo (JP)

(21) Appl. No.: 12/960,839

(22) Filed: Dec. 6, 2010

(30) Foreign Application Priority Data
Dec. 10, 2009 (JP) 2009-280583

(51) Int. Cl. G06Q 30/00; G06Q 40/00

(52) U.S. Cl. 705/16; 235/380

(57) ABSTRACT

According to one embodiment, a settlement terminal includes a card reading unit, an input unit, a card settlement unit, a cumulative storing unit, and a display unit. The card reading unit reads information stored in a card for settlement. The input unit inputs transaction information. The card settlement unit settles, using the card information read by the card reading unit and the transaction information input by the input unit, a commercial transaction related to the transaction information by card. The cumulative storing unit cumulatively stores predetermined numerical value information generated every time the commercial transaction is settled by card by the card settlement unit. The display unit displays a standby screen on which the start of the commercial transaction is received and a cumulative value of the numerical value information stored in the cumulative storing unit is shown.

### CROSS-REFERENCE TO RELATED APPLICATIONS

This application is based upon and claims the benefit of priority from Japanese Patent Application No. 2009-280583, filed on Dec. 10, 2009; the entire contents of which are incorporated herein by reference.

### FIELD

Embodiments described herein relate generally to a settlement terminal that subject a commercial transaction to settlement processing, a control method therefor, and a POS (Point Of Sales) terminal.

### BACKGROUND

In the past, a settlement terminal for card settlement and a POS terminal are used for checkout jobs for commercial transactions in various commodity sales stores or service providing stores.

Usually, in each of the stores, a daily total job is performed after business in one day ends. In the daily total job, the settlement terminal or the POS terminal causes a printer provided in the settlement terminal or the POS terminal to print or causes a display to display numerical value information generated as a result of transactions such as the number of transactions in one day, a total transaction amount, the number of transactions and a transaction amount by department to which commodities or the like belong, and the number of used notes and a used amount of notes. A store clerk visually checks these kinds of numerical value information to grasp a transaction result in one day and performs, for example, a check of over and shorts of proceeds and collation of stocks.

Depending on a store, it is desired to grasp, until business in one day ends, rough estimates of the number of transactions and a total transaction amount of the day. However, with the settlement terminal or the POS terminal in the past, it is impossible to learn the number of transactions and the total transaction amount of the day during a business hour of the store unless the daily total job is performed. Therefore, in order to grasp the number of transactions until the business in one day ends, it is necessary to perform the daily total job in the middle of the business. However, it is also likely that the business has to be suspended because the settlement terminal or the POS terminal cannot be used while the daily total job is performed.

On the other hand, in some case, a store clerk does not perform the daily total job at the end of business without knowing whether transactions are performed in the day or is convinced that the daily total job is already completed and fails to perform the daily total job. In such a case, it is necessary to quickly perform the daily total job for the preceding business day before the start of business in the following business day. If transactions in the following business day are processed in the settlement terminal or the POS terminal while the daily total job is not performed, sales management and inventory management are likely to be hindered.

Under such circumstances, it is necessary to take measures for making it possible to easily grasp a sales state in the day even during business of a store and prevent a failure to perform the daily total job.

### BRIEF DESCRIPTION OF THE DRAWINGS

FIG. 1 is an external perspective view of a settlement terminal according to a first embodiment;

FIG. 2 is a block diagram of a control circuit of the settlement terminal according to the first embodiment;

FIG. 3 is a schematic diagram of an example of a standby screen displayed on a display of the settlement terminal according to the first embodiment;

FIG. 4 is a flowchart for explaining basic processing executed by a CPU of the settlement terminal according to the first embodiment;

FIG. 5 is a flowchart for explaining warning processing executed by the CPU of the settlement terminal according to the first embodiment;

FIG. 6 is a diagram of an example of warning performed by using the standby screen displayed on the display of the settlement terminal according to the first embodiment;

FIG. 7 is a block diagram of a control circuit of a POS terminal according to a second embodiment;

FIG. 8 is a schematic diagram of an example of a standby screen displayed on a store-clerk side display of the POS terminal according to the second embodiment;

FIG. 9 is a flowchart for explaining processing executed in a job mode by a CPU of the POS terminal according to the second embodiment;

FIG. 10 is a flowchart for explaining processing executed in a totalizing mode by the CPU of the POS terminal according to the second embodiment; and

FIG. 11 is a diagram of an example of warning performed by using the standby screen displayed on the store-clerk side display of the POS terminal according to the second embodiment.

### DETAILED DESCRIPTION

In general, according to one embodiment, a settlement terminal includes a card reading unit, an input unit, a card settlement unit, a cumulative storing unit, and a display unit. The card reading unit reads information stored in a card for settlement. The input unit inputs transaction information. The card settlement unit settles, using the card information read by the card reading unit and the transaction information input by the input unit, a commercial transaction related to the transaction information by card. The cumulative storing unit cumulatively stores predetermined numerical value information generated every time the commercial transaction is settled by card by the card settlement unit. The display unit displays a standby screen on which the start of the commercial transaction is received and a cumulative value of the numerical value information stored in the cumulative storing unit is shown.

### First Embodiment

A first embodiment is explained below with reference to the drawings.

In this embodiment, a settlement terminal that settles a commercial transaction by card using a credit card or a debit card is explained as an example.

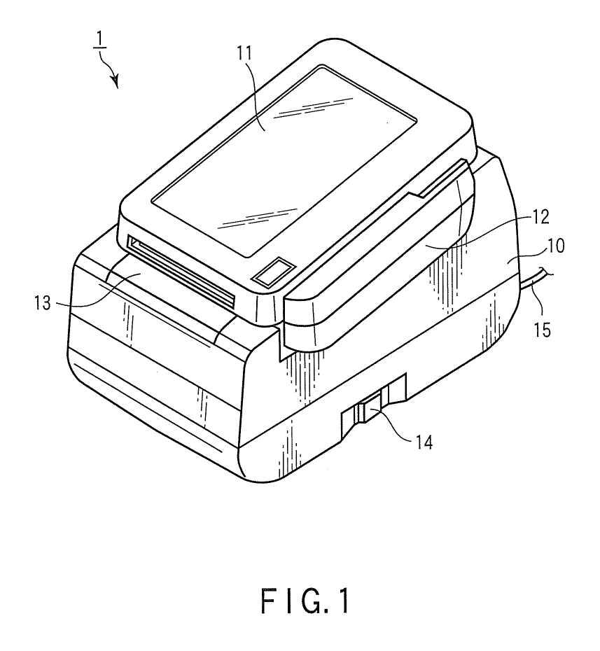

FIG. 1 is an external perspective view of the settlement terminal according to this embodiment.

A main body 10 of a settlement terminal 1 includes a display 11, a card reader 12, a receipt issue port 13, and a power switch 14. A communication cable 15 for communication connection to a store server of a store where the settlement terminal 1 is set and a control center operated by a settlement organization for a credit card or the like is extended from the rear of the main body 10.

A receipt printed by a receipt printer 16 explained later is discharged from the receipt issue port 13. The power switch 14 is a mechanical switch for turning on and off power supply from an external power supply such as a commercial AC power supply to the settlement terminal 1.

The display 11 functions as a display unit in this embodiment. The display 11 is an LCD (Liquid Crystal Display) on which a touch panel 17 is provided to cover a display surface thereof. A standby screen explained later and a screen corresponding to an operation mode of the settlement terminal 1 are selectively displayed on the display 11.

The card reader 12 functions as a card reading unit in this embodiment. The card reader 12 reads, according to sliding of a magnetic card such as a credit card or a debit card having a magnetic stripe, card information such as a card number stored in the magnetic stripe.

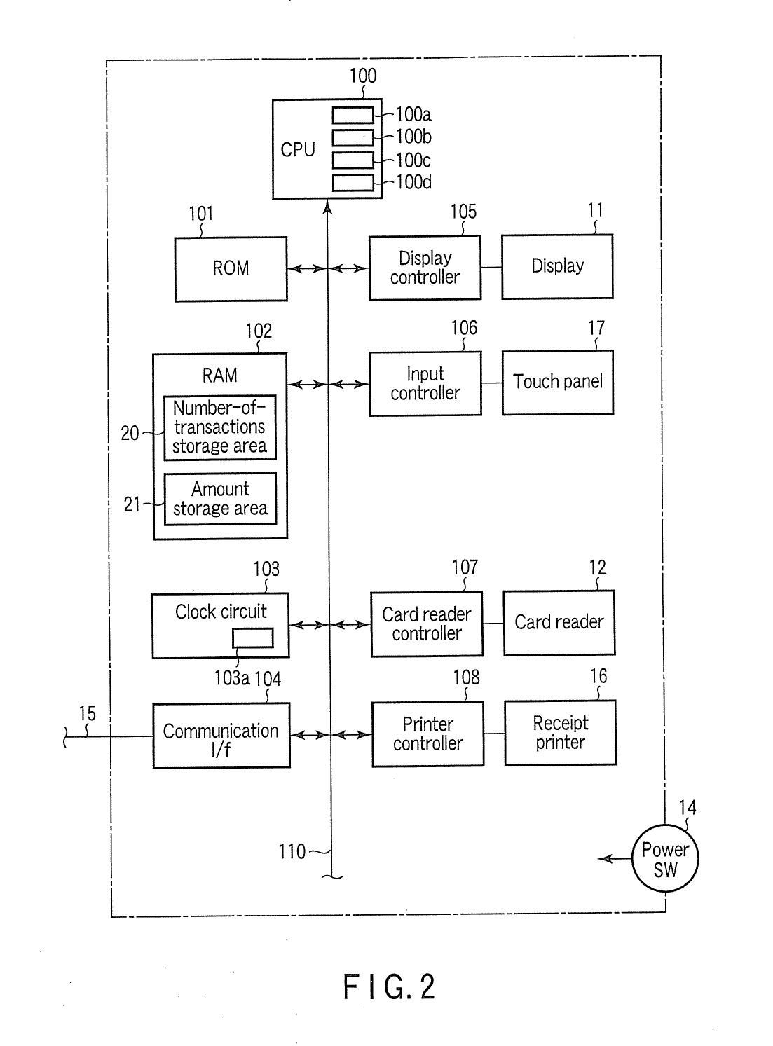

FIG. 2 is a block diagram of a control circuit of the settlement terminal 1. A CPU (Central Processing unit) 100 functioning as a main control unit is incorporated in the main body 10. A ROM (Read Only Memory) 101, a RAM (Random Access Memory) 102, a clock circuit 103, a communication I/F (Interface) 104, a display controller 105, an input controller 106, a card reader controller 107, a printer controller 108, and the like are connected to the CPU 100 via a bus line 110 such as an address bus or a data bus to configure the control circuit.

The communication cable 15 is connected to the communication I/F 104. The display 11 is connected to the display controller 105. The touch panel 17 is connected to the input controller 106. The card reader 12 is connected to the card reader controller 107. The receipt printer 16 is connected to the printer controller 108.

Various application files and databases for causing the settlement terminal 1 to realize operation modes such as a job mode, a totalizing mode, a setting mode, and a practice mode are stored in the ROM 101.

The job mode is an operation mode for receiving input of transaction information and settling a commercial transaction by card on the basis of the input transaction information. The totalizing mode is an operation mode for performing so-called daily total processing for subjecting specified items of accounts to totalizing processing on the basis of a sales result of a business day. The items of accounts are, for example, the number of transactions in one day, a total transaction amount, the number of transactions and a transaction amount by department of a commodity, and an amount of use of notes. The setting mode is an operation mode for performing various settings concerning the operation of the settlement terminal 1. The practice mode is an operation mode for performing simulations of respective kinds of processing in order to train an operator concerning the operation of the settlement terminal 1.

Various storage area for work such as a number-of-transactions storage area 20 and an amount storage area 21 functioning as a cumulative storing unit in this embodiment are formed in the RAM 102.

A cumulative number of commercial transactions settled by card in the settlement terminal 1 is stored in the number-of-transactions storage area 20. A cumulative transaction amount of commercial transactions settled by card in the settlement terminal 1 is stored in the amount storage area 21.

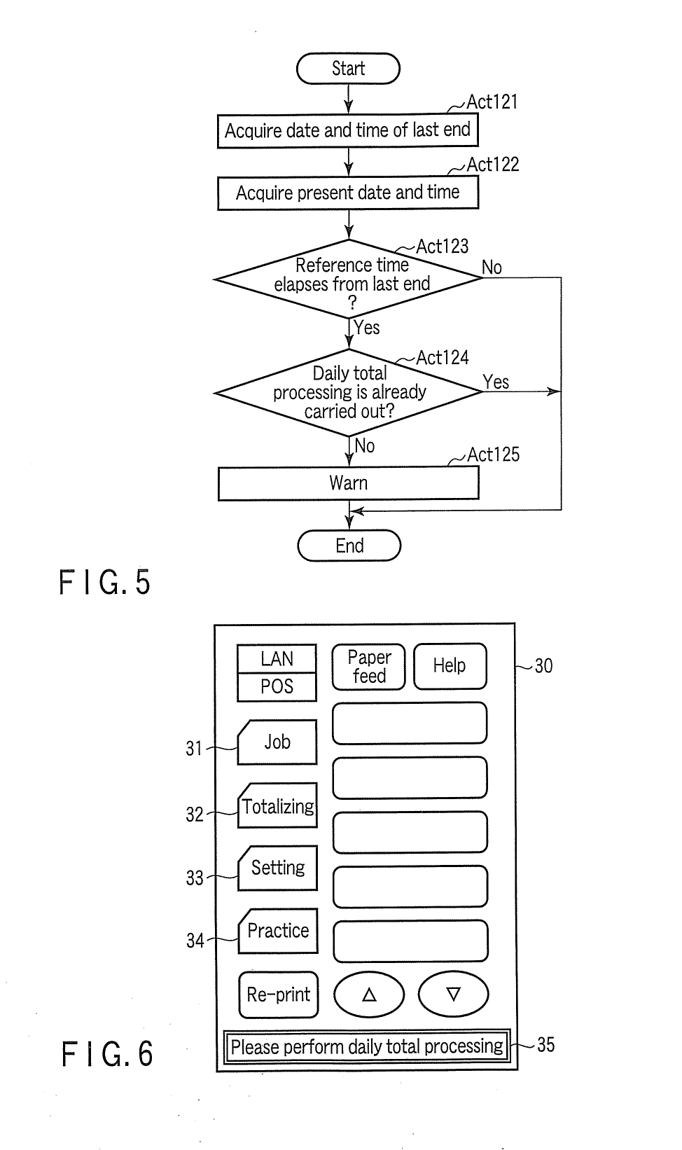

The clock circuit 103 functions as a timing unit in this embodiment. The clock circuit 103 measures system date and time used in the settlement terminal 1. The clock circuit 103 includes a nonvolatile memory 103a. When the power switch 14 is depressed in a state in which electric power is supplied and a system of the settlement terminal 1 is started, end processing for the system is executed. At this point, the clock circuit 103 stores the present date and time in the memory 103a. The date and time is used in warning processing explained later with reference to FIG. 5.

The communication I/F 104 functions as a communication unit in this embodiment. The communication I/F 104 controls communication with the store server and the control center performed via the communication cable 15.

The display controller 105 controls screen display of the display 11. The touch panel 17 functions as an input unit in this embodiment. The touch panel 17 outputs an electric signal corresponding to a position touch-operated by a user with a fingertip or a touch pen. The input controller 106 detects the operation of a GUI displayed on the display 11 on the basis of the electric signal output from the touch panel 17 and notifies the CPU 100 of a type of the operated GUI.

The card reader controller 107 controls reading timing for a magnetic card by the card reader 12 and notifies the CPU 100 of card information read by the card reader 12.

The receipt printer 16 is a so-called thermal printer configured to form, with heat transfer, a pattern including a character, a figure, or the like on a receipt sheet such as thermal recording paper. The printer controller 108 drives the receipt printer 16 on the basis of print data created in the RAM 102 to print a receipt or a journal.

The CPU 100 functions as units 100a to 100d explained below according to information processing performed by using software.
(1) A card settlement unit 100a configured to settle, using card information read by the card reader 12 and transaction information input by contact operation on the touch panel 17, a commercial transaction related to the transaction information by card.
(2) A daily-total processing unit 100b configured to subject specified items of accounts to totalizing processing on the basis of a sales result of a business day.
(3) An initializing unit 100c configured to initialize, when the totalizing processing by the daily-total processing unit 100b is performed, cumulative values of numerical value information stored in the number-of-transactions storage area 20 and the amount storage area 21, i.e., a cumulative number of transactions and a cumulative transaction amount.
(4) A warning unit 100d configured to warn, when a power supply is turned on, that the totalizing processing by the daily-total processing unit 100b is not carried out if the present date and time indicated by the clock circuit 103 satisfies a predetermined condition and the cumulative values of the numerical value information stored in the number-of-transactions storage area 20 and the amount storage area 21, i.e., the cumulative number of transactions and the cumulative transaction amount are not initialized by the initializing unit 100c.

A standby screen displayed on the display 11 is explained below.

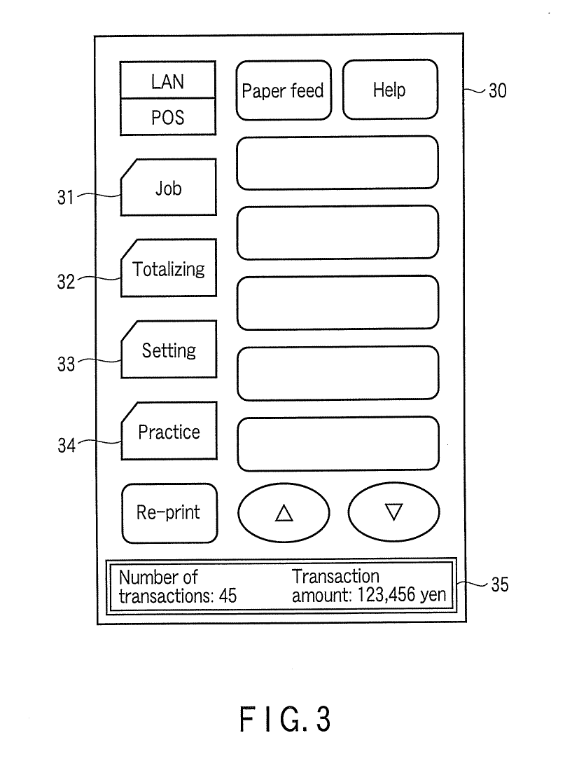

FIG. 3 is a schematic diagram of an example of the standby screen. This standby screen 30 is a screen on which an operator selects an operation mode for executing processing out of a job mode, a totalizing mode, a setting mode, a practice mode, and the like. The standby screen 30 is displayed on the display 11 immediately after electric power is input to the settlement terminal 1.

A job key 31, a totalizing key 32, a setting key 33, and a practice key 34 for respectively selecting the job mode, the totalizing mode, the setting mode, and the practice mode, a cumulative-information display area 35, and the like are displayed on the standby screen 30. When the job key 31, the totalizing key 32, the setting key 33, or the practice key 34 is touch-operated, a screen of the operation mode selected by the operated key is displayed on the standby screen 30 or displayed on the display 11 instead of the standby screen 30. The cumulative number of transactions stored in the number-of-transactions storage area 20 and the cumulative transaction amount stored in the amount storage area 21 are displayed in the cumulative-information display area 35.

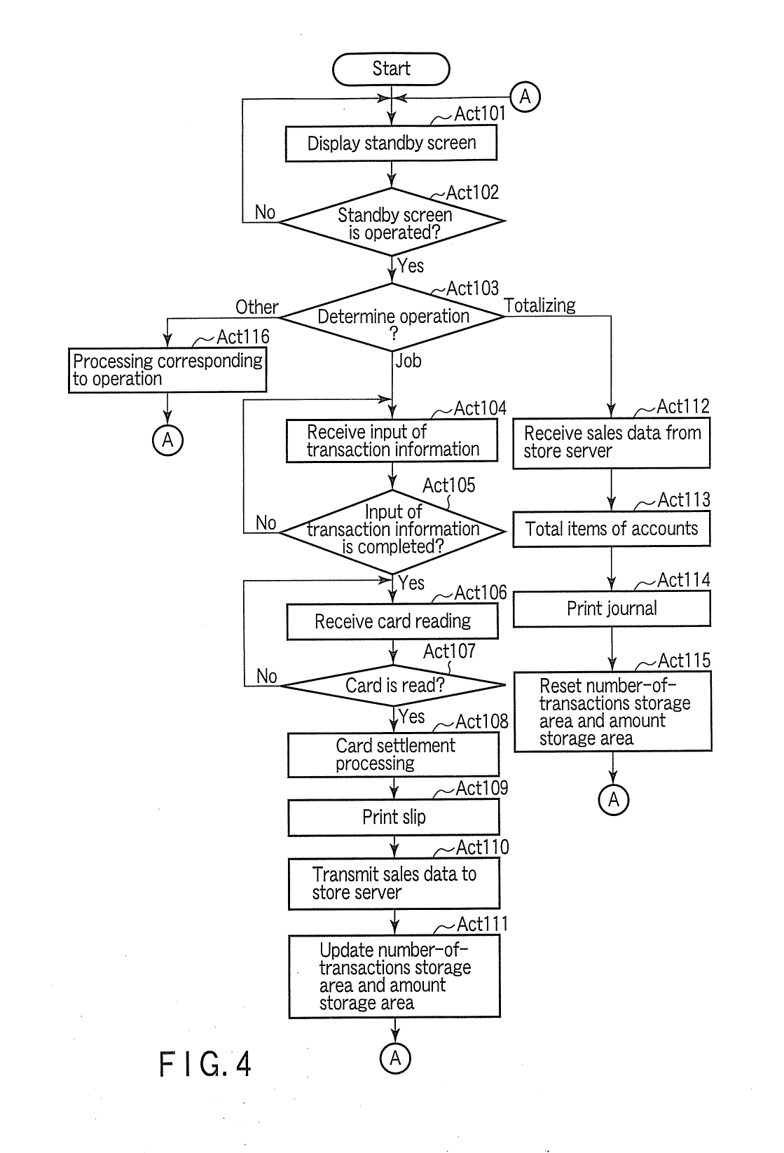

As explained later with reference to FIG. 4, when the job key 31 is operated, the settlement terminal 1 shifts to a state for receiving input of transaction information. In other words, the standby screen 30 is also a screen on which the start of a commercial transaction is received.

The operation of the settlement terminal 1 is explained below.

FIG. 4 is a flowchart for explaining basic processing executed by the CPU 100 of the settlement terminal 1.

First, the CPU 100 causes the display 11 to display the standby screen 30 via the display controller 105 (ACT 101) and waits for contact operation of the standby screen 30 (No in ACT 102).

If any one of the operation keys provided on the standby screen 30 is touch-operated (Yes in ACT 102), the CPU 100 determines the selected operation (ACT 103). If the job key 31 is operated (“job” in ACT 103), the CPU 100 waits for input of transaction information including a name and a price of a commodity or the like as a transaction target (ACT 104 and No in ACT 105). A store clerk operating the settlement terminal 1 at this point operates the touch panel 17 according to screen display of the display 11 to input transaction information of a commodity or the like that a customer is about to purchase.

When the store clerk finishes inputting the transaction information concerning all commodities or the like that the customer is about to purchase, the store clerk operates the touch panel 17 according to the screen display of the display 11 to declare the completion of the input of the transaction information. At this point, the CPU 100 determines that the input of the transaction information is completed (Yes in ACT 105) and stays on standby in a state for receiving reading of a card for settlement such as a credit card by the card reader 12 (ACT 106 and No in ACT 107). If the card for settlement is read by the card reader 12 (Yes in ACT 107), the CPU 100 executes card settlement processing according to a known procedure using read card information and the transaction information, the input of which is received in ACT 104 (ACT 108). In this processing, the CPU 100 performs for example, input of a personal identification number via a not-shown pin pad, establishment of communication with a control center for the card for settlement, transmission of the card information and the personal identification number to the control center, reception of an authentication result and a credit inquiry result of the personal identification number, transmission of the transaction information to the control center, and reception of an authorization result.

When the card settlement processing is completed, the CPU 100 drives the receipt printer 16 via the printer controller 108 to print three slips including detailed information of the transaction respectively for a store, a credit card company, and a customer (ACT 109). After printing the slips, the CPU 100 transmits sales data including the detailed information of the transaction to the store server via the communication I/F 104 (ACT 110). The store server stores and manages the sales data received from the settlement terminal 1.

In this way, the card settlement for the commercial transaction is completed. The processing in ACTS 108 to 110 is realized mainly by the card settlement unit 100a.

After transmitting the sales data to the store server, the CPU 100 updates the number-of-transactions storage area 20 and the amount storage area 21 (ACT 111). Specifically, the CPU 100 adds the number of transactions “1”, which is numerical value information generated in the transaction, to the cumulative number of transactions stored in the number-of-transactions storage area 20 and updates the cumulative number of transactions stored in the number-of-transactions storage area 20 with a numerical value after the addition. Further, the CPU 100 adds a total amount of the transaction, which is numerical value information generated in the transaction, to the cumulative transaction amount stored in the amount storage area 21 and updates the cumulative transaction amount stored in the amount storage area 21 with a numerical value after the addition.

Consequently, the CPU 100 completes the job processing related to the one transaction, returns to A in the figure, and causes the display 11 to display the standby screen 30 again (ACT 101). The number of transactions and a transaction amount displayed in the cumulative-information display area 35 of the standby screen 30 are numerical values reflecting contents of the series of transaction.

Usually, after store business of one day ends, daily total processing is performed to totalize sales data of the day. In performing this processing, the operator touch-operates the totalizing key 32 displayed on the standby screen 30.

If the totalizing key 32 is touch-operated (“totalizing” in ACT 103), the CPU 100 accesses the store server, which manages sales data, and receives sales data generated after the last daily total processing is performed (ACT 112). When the sales data is received, the CPU 100 totalizes the items of accounts set in advance using the sales data and causes the display 11 to display a totalizing result via the display controller 105 (ACT 113). Further, the CPU 100 causes the printer controller 108 to drive the receipt printer 16 to print a journal on which the sales data arrayed in time series and the items of accounts are shown (ACT 114). This journal is used for sales management and the like of the store. The processing in ACTS 112 to 114 is realized mainly by the daily-total processing unit 100b.

After printing the journal, the CPU 100 resets the cumulative number of transactions and the cumulative transaction amount stored in the number-of-transactions storage area 20 and the amount storage area 21 to 0 and 0 yen (ACT 115). The processing in ACT 115 is realized mainly by the initializing unit 100c.

After resetting the cumulative number of transactions and the cumulative transaction amount, the CPU 100 returns to A in the figure and causes the display 11 to display the standby screen 30 again (ACT 101). The number of transactions and a transaction amount displayed in the cumulative-information display area 35 of the standby screen 30 at this point are the numerical values after the reset, i.e., 0 and 0 yen.

If any one of the other operation keys such as the setting key 33 and the practice key 34 is operated in a state in which the standby screen 30 is displayed (“other” in ACT 103), the CPU 100 executes processing corresponding to the operated key (ACT 116), returns to A in the figure, and causes the display 11 to display the standby screen 30 again (ACT 101). The explanation of the series of processing shown in FIG. 4 ends here.

When the standby screen 30 is displayed on the display 11 immediately after electric power is input to the settlement terminal 1 (ACT 101), the CPU 100 executes warning processing for warning a failure to perform the daily total processing.

In the warning processing, the CPU 100 operates according to a flowchart of FIG. 5. Specifically, first, the CPU 100 acquires date and time of the last system end stored in the memory 103a of the clock circuit 103 (ACT 121). Further, the CPU 100 acquires the present date and time from the clock circuit 103 (ACT 122). The CPU 100 compares the acquired date and time of the last system end and the present date and time and determines whether reference time elapses from the last system end to the present (ACT 123). The reference time is, for example, time set between a business end hour and a business start hour of the following day of the store and is stored in the ROM 101 in advance.

As explained above, usually, the daily total processing is performed after store business of one day ends. Therefore, if it is determined in the operation of ACT 123 that the reference time elapses from the last system end to the present, the daily total processing has to be already performed.

If it is determined that the reference time elapses from the last system end to the present (Yes in ACT 123), the CPU 100 determines whether the daily total processing is already carried out (ACT 124). This determination is performed on the basis of whether the cumulative number of transactions and the cumulative transaction amount stored in the number-of-transactions storage area 20 and the amount storage area 21 are reset to 0 and 0 yen.

If the cumulative number of transactions and the cumulative transaction amount stored in the number-of-transactions storage area 20 and the amount storage area 21 are not reset to 0 and 0 yen, the CPU 100 determines that the daily total processing is not carried out yet (No in ACT 124). In this case, the CPU 100 warns the operator that the daily total processing is not carried out yet (ACT 125). This warning is performed by, for example, as shown in FIG. 6, displaying a message “Please perform daily total processing” in the cumulative-information display area 35 of the standby screen 30. However, this message is only an example. Other messages for informing the operator that the daily total processing is not carried out yet may be displayed. The warning may be performed by, for example, outputting sound from a not-shown speaker.

After performing the warning in this way, the CPU 100 completes the series of processing shown in FIG. 5. The processing in ACTS 121 to 125 is realized mainly by the warning unit 100d.

As explained above, the settlement terminal 1 according to this embodiment always displays a cumulative number of transactions and a cumulative transaction amount since the last daily total processing on the standby screen 30 of the display 11. Consequently, the store clerk can easily check a sales state of the day without performing the daily total processing even in the middle of business of the store. The store clerk can learn at a glance whether transactions are performed in the day if the store clerk looks at the cumulative number of transactions and the cumulative transaction amount displayed on the standby screen 30. Therefore, it is possible to prevent a failure to perform the daily total processing.

Usually, credit slips for the store and the credit company issued from the receipt printer 16 of the settlement terminal 1 are bound for one business day and stored in a register counter or the like. If a cumulative number of transactions is displayed on the standby screen 30 as in this embodiment, the store clerk can easily collate the number of credit slits for the day and a cumulative number of transactions of the day at any time.

If, when the power supply is turned on, the reference time elapses from the last system end to the present and the daily total processing is not carried out yet, the settlement terminal 1 warns to that effect. Therefore, if the daily total processing for the previous day is not carried out yet when the settlement terminal 1 is started at the start of business of the store, it is possible to surely inform the store clerk as the operator to that effect.

### Second Embodiment

A second embodiment is explained below with reference to the drawings.

In this embodiment, a POS terminal that receives input of transaction information (commodity information) by, for example, reading a barcode with a scanner and subjects a commercial transaction to settlement processing using the input transaction information is explained as an example.

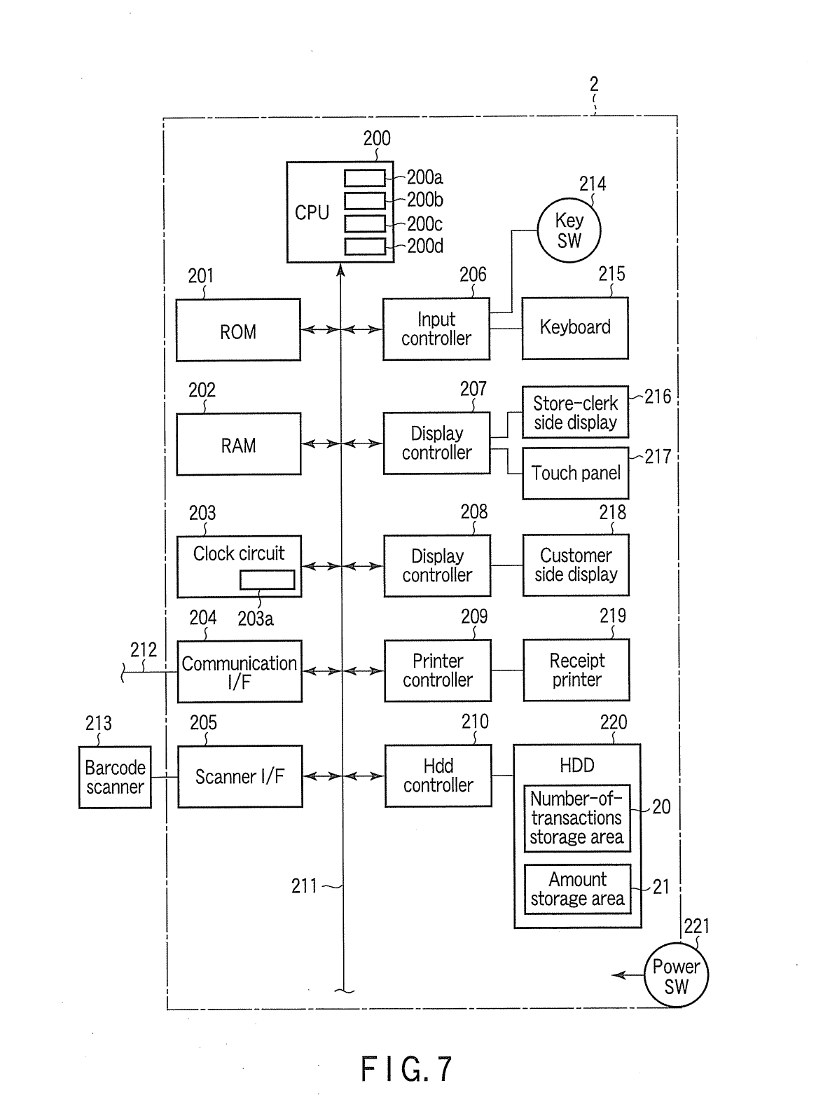

FIG. 7 is a block diagram of a control circuit of a POS terminal 2 according to this embodiment. A CPU 200 functioning as a main control unit is incorporated in a main body of the POS terminal 2. A ROM 201, a RAM 202, a clock circuit 203, a communication I/F 204, a scanner I/F 205, an input controller 206, display controllers 207 and 208, a printer controller 209, a HDD (Hard Disk Drive) controller 210, and the like are connected to the CPU 200 via a bus line 211 such as an address bus or a data bus to configure the control circuit.

A communication cable 212 for performing data communication with the store server is connected to the communication I/F 204. A barcode scanner 213 configured to optically read a barcode is connected to the scanner I/F 205. A key switch 214 for operation mode switching and a keyboard 215 are connected to the input controller 206. A store-clerk side display 216 and a touch panel 217, display surfaces of which are faced to a standing position side of a store clerk who operates the POS terminal 2, are connected to the display controller 207. A customer side display 218, a display surface of which is faced to a standing position side of a customer, is connected to the display controller 208. A receipt printer 219 is connected to the printer controller 209. A HDD 220 is connected to the HDD controller 210. A power switch 221 for turning on and off power supply from an external power supply such as a commercial AC power supply is provided in the main body of the POS terminal 2. The units included in the control circuit receive the power supply from the external power supply and operate.

Stationary data such as a BIOS is stored in the ROM 201. Various storage areas for work are formed in the RAM 202.

The clock circuit 203 functions as a timing unit in this embodiment. The clock circuit 203 measures system date and time used in the POS terminal 2. The clock circuit 203 includes a nonvolatile memory 203a. When the, power switch 221 is depressed in a state in which electric power is supplied and a system of the POS terminal 2 is started, end processing for the system is executed. At this point, the clock circuit 203 stores the present date and time in the memory 203a. This date and time is used in warning processing explained later.

The communication I/F 204 functions as a communicating unit in this embodiment. The communication I/F 204 controls communication with the store server performed via the communication cable 212.

The key switch 214 can be operated to turn by using an operation key owned by the store clerk. The key switch 214 generates a mode switching signal corresponding to a stop position of the turn. The keyboard 215 includes operation keys such as a PLU key for declaring the start of input of commodity information, a subtotal key for declaring the completion of the commodity information input, and a closing key for declaring closing of a transaction. The keyboard 215 generates a key signal corresponding to a depressed operation key. The input controller 206 captures the mode switching signal generated by the key switch 214 and the key signal generated by the keyboard 215 and notifies the CPU 200 of the signals. When the CPU 200 receives the notification of the mode switching signal, the CPU 200 switches an operation mode of the POS terminal 2 among a job mode, a totalizing mode, a setting mode, and the like according to the signal. When the CPU 200 receives the notification of the key signal, the CPU 200 executes processing corresponding to the signal.

The store-clerk side display 216 functions as a display unit in this embodiment. The store-clerk side display 216 selectively displays a standby screen or the like explained later and a screen corresponding to an operation mode of the POS terminal 2. The touch panel 217 outputs an electric signal corresponding to a position touch-operated by a user with a fingertip or a touch pen. The display controller 207 controls screen display of the store-clerk side display 216, detects the operation of a GUI displayed on the store-clerk side display 216 on the basis of the electric signal output from the touch panel 217, and notifies the CPU 200 of a type of the operated GUI. The touch panel 217 and the barcode scanner 213 function as an input unit in this embodiment.

The customer side display 218 is, for example, a VFD (Vacuum Fluorescent Display). The customer side display 218 displays, to the customer, commodity information or the like input to the POS terminal 2. The display controller 208 controls screen display of the customer side display 218.

The receipt printer 219 is a so-called thermal printer configured to form, with heat transfer, a pattern including a character, a figure, or the like on a receipt sheet such as thermal recording paper. The printer controller 209 drives the receipt printer 219 on the basis of print data created in the RAM 202 to print a receipt or a journal.

The HDD 220 stores various application files and databases for causing the POS terminal 2 to realize the job mode, the totalizing mode, the setting mode, the practice mode, and the like and the number-of-transactions storage area 20, the amount storage area 21, and the like functioning as a cumulative storing unit in this embodiment. A cumulative number of commercial transactions settled by the POS terminal 2 is stored in the number-of-transactions storage area 20. A cumulative transaction amount of commercial transactions settled by the POS terminal 2 is stored in the amount storage area 21. The HDD controller 210 controls writing of data in and readout of data from the HDD 220.

The CPU 200 functions as units 200a to 200d explained below according to information processing performed by using software.
(5) A settling unit 200a configured to settle, using transaction information (commodity information) input by reading of a barcode by the barcode scanner 213 or touch operation on the touch panel 217, a commercial transaction related to the transaction information.
(6) A daily-total processing unit 200b configured to subject specified items of accounts to totalizing processing on the basis of a sales result of a business day.
(7) An initializing unit 200c configured to initialize, when the totalizing processing by the daily-total processing unit 200b is performed, cumulative values of numerical value information stored in the number-of-transactions storage area 20 and the amount storage area 21, i.e., a cumulative number of transactions and a cumulative transaction amount.
(8) A warning unit 200d configured to warn, when a power supply is turned on, that the totalizing processing by the daily-total processing unit 200b is not carried out if the present date and time indicated by the clock circuit 203 satisfies a predetermined condition and the cumulative values of the numerical value information stored in the number-of-transactions storage area 20 and the amount storage area 21, i.e., the cumulative number of transactions and the cumulative transaction amount are not initialized by the initializing unit 200c.

A standby screen displayed on the store-clerk side display 216 is explained below.

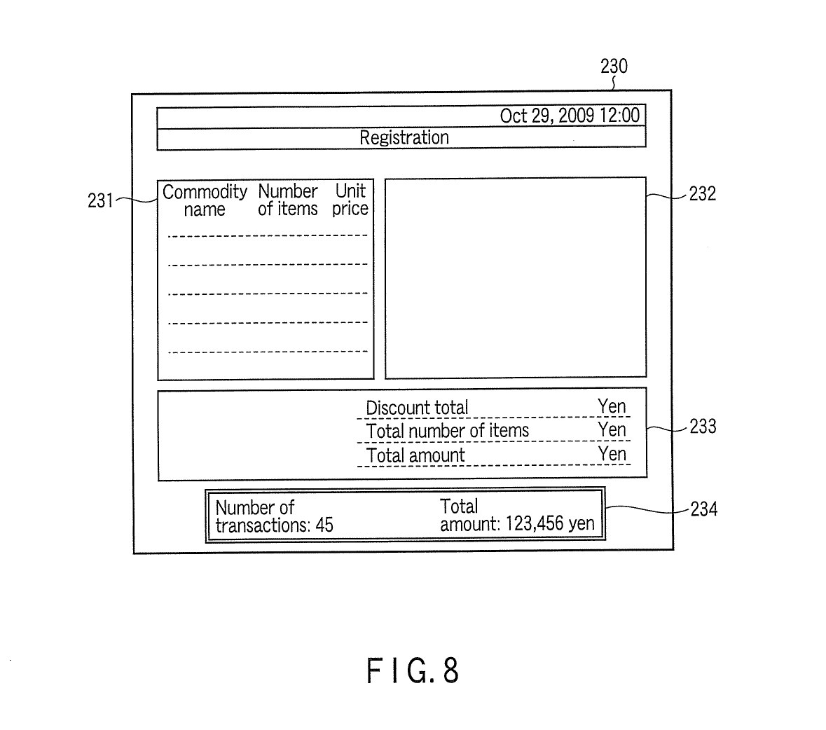

FIG. 8 is a schematic diagram of an example of the standby screen. This standby screen 230 is a screen displayed when the job mode is selected by the key switch 214.

A commodity-information display area 231, a preset-key display area 232, a total-amount and the like display area 233, and a cumulative-information display area 234 are displayed on the standby screen 230. A commodity name, a unit price, and the number of purchased items of the commodity in commodity information input by, for example, reading of a barcode by the barcode scanner 213 are displayed in the commodity-information display area 231. A preset key for inputting commodity information of a commodity not attached with a barcode is displayed in the preset-key display area 232. A total number of items, a total amount, a discount total amount of the transaction, and the like of respective kinds of commodity information displayed in the commodity-information display area 231 are displayed in the total-amount and the like display area 233. The cumulative number of transactions stored in the number-of-transactions storage area 20 and the cumulative transaction amount stored in the amount storage area 21 are displayed in the cumulative-information display area 234.

When the PLU key provided in the keyboard 215 is depressed in a state in which the standby screen 230 is displayed, a checkout job for the commercial transaction is started. At this point, it is possible to input, commodity information by reading of a barcode by the barcode scanner 213 and touch operation of the preset key displayed in the preset-key display area 232. In other words, the standby screen 230 is a screen for receiving input of commodity information.

The operation of the POS terminal 2 is explained below.

In starting store business of one day, an operator of the POS terminal 2 inserts an operation key into the key switch 214 and turns the operation key to a position for switching to the job mode. According to the turn of the operation key, the operation mode of the POS terminal 2 is switched to the job mode.

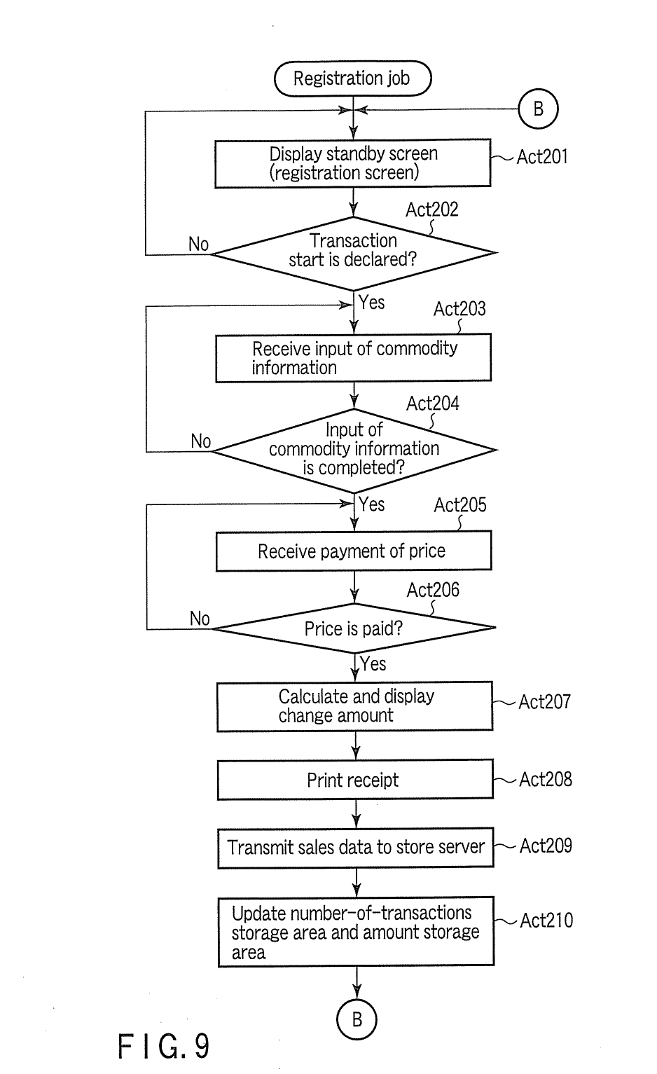

FIG. 9 is a flowchart for explaining processing executed by the CPU 200 in the job mode.

First, the CPU 200 causes the store-clerk side display 216 to display the standby screen 230 via the display controller 207 (ACT 201) and waits for declaration of the start of a transaction (No in ACT 202).

When the PLU key provided in the keyboard 215 is operated, the CPU 200 determines that the start of a transaction is declared (Yes in ACT 202). In a state for receiving input of commodity information (ACT 203), the CPU 200 waits for the completion of the input of the commodity information (No in ACT 204). At this point, a cashier can input commodity information by reading a barcode attached to a commodity with the barcode scanner 213 or operating the preset key displayed in the preset-key display area 232. The input commodity information is registered in a storage area formed in the RAM 202 and displayed in the commodity-information display area 231.

When finishing inputting all kinds of commodity information, the cashier depresses the subtotal key provided in the keyboard 215. When the subtotal key is depressed, the CPU 200 determines that the input of the commodity information is completed (Yes in ACT 204), calculates a total amount of the transaction, and displays the total amount on the total-amount and the like display area 233 and the customer side display 218. In a state for receiving payment of a price (ACT 205), the CPU 200 waits for completion of the payment (No in ACT 206). At this point, the cashier operates the keyboard 215 and inputs a deposit amount of a customer. A card reader or a communication terminal for communication with an electronic money may be connected the POS terminal 2 to receive payment of a price by a credit card or electronic money.

If the payment of the price is completed (Yes in ACT 206), the CPU 200 subtracts the total amount of the transaction from the deposit amount to calculate a change amount and displays the change amount on the store-clerk side display 216 and the customer side display 218 (ACT 207). Further, the CPU 200 drives the receipt printer 219 via the printer controller 209 to print a receipt including detailed information of the transaction (ACT 208). This receipt is passed from the cashier to the customer together with the change.

After printing the receipt, the CPU 200 transmits sales data including the detailed information of the transaction to the store server via the communication I/F 204 (ACT 209). The store server stores and manages the sales data received from the POS terminal 2.

In this way, the settlement of the commercial transaction is completed. The processing in ACTS 205 to 209 is realized mainly by the settling unit 200a.

After transmitting the sales data to the store server, the CPU 200 updates the number-of-transactions storage area 20 and the amount storage area 21 (ACT 210). Specifically, the CPU 200 adds the number of transactions “1”, which is numerical value information generated in the transaction, to the cumulative number of transactions stored in the number-of-transactions storage area 20 and updates the cumulative number of transactions stored in the number-of-transactions storage area 20 with a numerical value after the addition. Further, the CPU 200 adds a total amount of the transaction, which is numerical value information generated in the transaction, to the cumulative transaction amount stored in the amount storage area 21 and updates the cumulative transaction amount stored in the amount storage area 21 with a numerical value after the addition. The number of transactions and a transaction amount displayed in the cumulative-information display area 234 of the standby screen 230 are numerical values reflecting contents of the series of transaction.

Consequently, the CPU 200 completes the job processing related to the one transaction, returns to B in the figure, clears the display contents of the commodity-information display area 231 and the total-amount and the like display area 233, and waits for the start of the next transaction (ACT 201 and No in ACT 202).

Usually, after store business of one day ends, daily total processing is performed to totalize sales data of the day. In performing this processing, the operator inserts the operation key into the key switch 214 and turns the operation key to a position for switching to the totalizing mode. According to the turn of the operation key, the operation mode of the POS terminal 2 is switched to the totalizing mode.

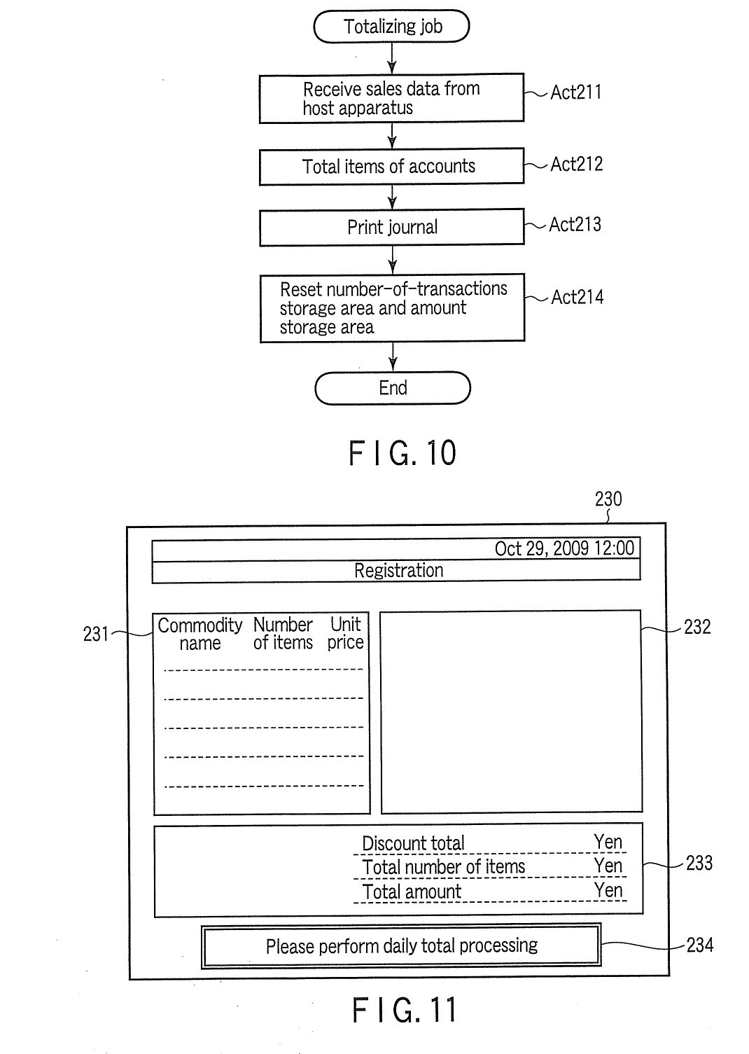

FIG. 10 is a flowchart for explaining processing executed by the CPU 200 in the totalizing mode.

First, the CPU 200 accesses the store server, which manages sales data, via the communication I/F 204 and receives sales data generated after the last daily total processing is performed (ACT 211). When the CPU 200 receives the sales data, the CPU 200 totalizes the items of accounts set in advance using the sales data and causes the store-clerk side display 216 to display a totalizing result via the display controller 207 (ACT 212). Further, the CPU 200 drives the receipt printer 219 via the printer controller 209 to print a journal on which the sales data arrayed in time series and the items of accounts are shown (ACT 213). This journal is used for sales management and the like of the store. The processing in ACTS 211 to 213 is realized mainly by the daily-total processing unit 200b.

After printing the journal, the CPU 200 resets the number of transactions and the transaction amount stored in the number-of-transactions storage area 20 and the amount storage area 21 to 0 and 0 yen (ACT 214) and ends the series of processing in the totalizing mode. The processing in ACT 214 is realized mainly by the initializing unit 200c.

After performing the daily total processing of such a flow, when the operator turns the operation key in the key switch 214 to a switching position for the job mode and switches the operation mode to the job mode, the standby screen 230 on which the cumulative number of transactions and the cumulative transaction amount in the cumulative-information display area 234 are changed to numerical values after reset, i.e., 0 and 0 yen is displayed on the store-clerk side display 216.

When the standby screen 230 is displayed on the store-clerk side display 216 immediately after electric power is input to the POS terminal 2 (ACT 201), the CPU 200 executes warning processing for warning a failure to perform the daily total processing.

In the warning processing, the CPU 200 operates according to a flow basically the same as the flowchart of FIG. 5. Specifically, first, the CPU 200 acquires date and time of the last system end stored in the memory 203a of the clock circuit 203 (ACT 121). Further, the CPU 200 acquires the present date and time from the clock circuit 203 (ACT 122). The CPU 200 compares the acquired date and time of the last system end and the present date and time and determines whether reference time elapses from the last system end to the present (ACT 123). The reference time is, for example, time set between a business end hour and a business start hour of the following day of the store and is stored in the ROM 201 in advance.

If it is determined that the reference time elapses from the last system end to the present (Yes in ACT 123), the CPU 200 determines whether the daily total processing is already carried out (ACT 124).

If the cumulative number of transactions and the cumulative transaction amount stored in the number-of-transactions storage area 20 and the amount storage area 21 are not reset to 0 and 0 yen, the CPU 200 determines that the daily total processing is not carried out yet (No in ACT 124). In this case, the CPU 200 warns the operator that the daily total processing is not carried out yet (ACT 125). This warning is performed by, for example, as shown in FIG. 11, displaying a message “Please perform daily total processing” in the cumulative-information display area 234 of the standby screen 230. However, this message is only an example. Other messages for informing the operator that the daily total processing is not carried out yet may be displayed. The warning may be performed by, for example, outputting sound from a not-shown speaker.

After performing the warning in this way, the CPU 200 completes the series of processing shown in FIG. 5. The processing in ACTS 121 to 125 is realized mainly by the warning unit 200d.

As explained above, the POS terminal 2 according to this embodiment always displays a cumulative number of transactions and a cumulative transaction amount since the last daily total processing on the standby screen 230 of the store-clerk side display 216. Therefore, as in the first embodiment, the store clerk can easily check a sales state of the day and it is possible to prevent a failure to perform the daily total processing.

If, when the power supply is turned on, the reference time elapses from the last system end to the present and the daily total processing is not carried out yet, the POS terminal 2 warns to that effect. Therefore, as in the first embodiment, if the daily total processing for the previous day is not carried out yet when the POS terminal 2 is started at the start of business of the store, it is possible to surely inform the store clerk as the operator to that effect.

Besides, it goes without saying that effects same as those in the first embodiment are realized.

### Modifications

In the first embodiment, a cumulative number of transactions and a cumulative transaction amount are always displayed on the standby screen 30 for selecting the operation modes such as the job mode, the totalizing mode, the setting mode, and the practice mode. In the second embodiment, a cumulative number of transactions and a cumulative transaction amount are always displayed on the standby screen 230 for receiving input of transaction information (commodity information). Therefore, the standby screens in the embodiments may be screens for waiting for other operations. Various screens can be adopted as the standby screens for displaying a cumulative number of transactions and a cumulative transaction amount. However, it is desirable to adopt a screen displayed for a long time on a display screen for operator in a business hour of a store such that a store clerk easily notice the screen.

In the explanation of the embodiments, a cumulative number of transactions and a cumulative transaction amount are adopted as numerical value information displayed on the standby screen. However, only one of the cumulative number of transactions and the cumulative transaction amount may be displayed on the standby screen. Alternatively, numerical value information generated in each commercial transaction other than the cumulative number of transactions and the cumulative transaction amount may be adopted as the numerical value information displayed on the standby screen. Even when information displayed on the standby screen is changed in this way, it is possible to distinguish at a glance whether transactions are performed since the last daily total processing.

A function for making it possible to arbitrarily select numerical value information displayed on the standby screen may be provided in the settlement terminal 1 and the POS terminal 2. Consequently, optimum setting suitable for an operation state of the store can be easily realized even after the settlement terminal 1 and the POS terminal 2 are shipped from a manufacturer. Therefore, convenience of use of the settlement terminal 1 and the POS terminal 2 is improved.

Further, in the embodiments, when electric power is input to the settlement terminal 1 and the POS terminal 2, if the reference time elapses from the last system end to the present and the daily total processing is not carried out, it is warned that the daily total processing is not carried out yet. However, a condition for this warning may be other conditions. For example, it may be warned that the daily total processing is not carried out yet if the present date and time belongs to a predetermined time range and the daily total processing is not carried out. Alternatively, it may be warned that the daily total processing is not carried out if a date changes and the daily total processing is not carried out.

In the explanation in the embodiment, the monetary unit is Japanese Yen. However, the monetary unit may also be other such as US dollar.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement terminal comprising:
a card reading unit configured to read information stored in a card for settlement;
an input unit configured to input transaction information;
a card settlement unit configured to settle, using the card information read by the card reading unit and the transaction information input by the input unit, a commercial transaction related to the transaction information by card;
a cumulative storing unit configured to cumulatively store predetermined numerical value information generated every time the commercial transaction is settled by card by the card settlement unit; and
a display unit configured to display a standby screen on which start of the commercial transaction is received and a cumulative value of the numerical value information stored in the cumulative storing unit is shown.

2. The terminal according to claim 1, wherein the numerical value information includes at least one of a number of transactions settled by card in the terminal and a sales amount of the transactions settled by card in the terminal.

3. The terminal according to claim 1, further comprising:
a daily-total processing unit configured to subject specified items of accounts to totalizing processing on the basis of a sales result of a business day; and
an initializing unit configured to initialize, when the totalizing processing by the daily-total processing unit is performed, the cumulative value of the numerical value information stored in the cumulative storing unit.

4. The terminal according to claim 3, further comprising:
a timing unit configured to measure date and time; and
a warning unit configured to warn, if present date and time indicated by the timing unit satisfies a predetermined condition and the cumulative value of the numerical value information stored in the cumulative storing unit is not initialized by the initializing unit, that the totalizing processing by the daily-total processing unit is not carried out yet.

5. The terminal according to claim 4, wherein the warning unit performs the warning by displaying, on the standby screen, a message indicating that the totalizing processing by the daily-total processing unit is not carried out yet.

6. A control method for a settlement terminal including a card reading unit configured to read information stored in a card, an input unit configured to input transaction information, a display unit configured to display a standby screen for receiving start of a commercial transaction, and a storing unit, the control method comprising:
reading, with the card reading unit, information stored in a card for settlement;
receiving the input of the transaction information by the input unit;
settling, using the card information read by the card reading unit and the transaction information input by the input unit, a commercial transaction related to the transaction information by card;
adding predetermined numerical value information generated according to the card settlement of the commercial transaction to a cumulative value of the numerical value information generated by commercial transactions in the past and stored in the storing unit and updating the cumulative value stored in the storing unit with a cumulative value after the addition; and
causing the standby screen to display the cumulative value after the update stored in the storing unit.

7. A POS terminal comprising:
an input unit configured to input transaction information;
a settling unit configured to settle a commercial transaction related to the transaction information using the transaction information input by the input unit;
a cumulative storing unit configured to cumulatively store predetermined numerical value information generated every time the commercial transaction is settled by the settling unit; and
a display unit configured to display a standby screen on which input of the transaction information by the input unit is received and a cumulative value of the numerical value information stored in the cumulative storing unit is shown.

8. The terminal according to claim 7, wherein the numerical value information includes at least one of a number of transactions settled in the terminal and a sales amount of the transactions settled in the terminal.

9. The terminal according to claim 7, further comprising:
a daily-total processing unit configured to subject specified items of accounts to totalizing processing on the basis of a sales result of a business day; and
an initializing unit configured to initialize, when the totalizing processing by the daily-total processing unit is performed, the cumulative value of the numerical value information stored in the cumulative storing unit.

10. The terminal according to claim 9, further comprising:
a timing unit configured to measure date and time; and
a warning unit configured to warn, if present date and time indicated by the timing unit satisfies a predetermined condition and the cumulative value of the numerical value information stored in the cumulative storing unit is not initialized by the initializing unit, that the totalizing processing by the daily-total processing unit is not carried out yet.
